(19) United States
(12) Patent Application Publication
(10) Pub. No.: US 2016/0210335 A1
(43) Pub. Date: Jul. 21, 2016

(54) SERVER AND SERVICE SEARCHING METHOD OF THE SERVER

(71) Applicant: FIH (HONG KONG) LIMITED, Kowloon (HK)

(72) Inventor: TING-HSUAN CHENG, New Taipei (TW)

(21) Appl. No.: 14/755,342

(22) Filed: Jun. 30, 2015

(30) Foreign Application Priority Data
Jan. 19, 2015 (TW) 104101726

(51) Int. Cl. G06F 17/30

(52) U.S. Cl. CPC G06F 17/30554; G06F 17/30424; G06F 17/30867

(57) ABSTRACT

In a service searching method of a server, a searching interface is transmitted to a client device, and the searching interface includes icons of a plurality of service categories. The server receives a service category selected from the searching interface and a keyword input from the searching user interface by the client device. One or more websites corresponding to the selected service category are confirmed, and the method searches for search results which are related to the input keyword from the confirmed websites. The search results are sorted in a preset manner and output in a preset format to be displayed on a display screen of the client device.

### CROSS-REFERENCE TO RELATED APPLICATIONS

This application claims priority to Taiwan Patent Application No. 104101726 filed on Jan. 19, 2015, the contents of which are incorporated by reference herein.

### FIELD

The subject matter herein generally relates to searching technology, and particularly to a server and a service searching method of the server.

### BACKGROUND

Websites can provide various services for users. A web portal can provide links of a plurality of websites together to be selected for information searching services. However, the plurality of websites provided by the web portal are disordered and cluttered. If a user inputs one or more keywords in the web portal, a plurality of repeated results may be found and a category of the results may not be desired. If the user wants to find a service with a target category, the user needs to find a link of a website which provides the service with the target category from a plurality of websites, and then input one or more keywords in the website to search for the service. It is inconvenient and inefficient for users to search services with a target category.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a server.

FIG. 2 is a block diagram of an example embodiment of a service searching system in the server of FIG. 1.

FIG. 3 is a diagrammatic view of an example embodiment of searching interface provided by the service searching system of FIG. 2.

FIG. 4 is a flowchart of an example embodiment of a service searching method of the server of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

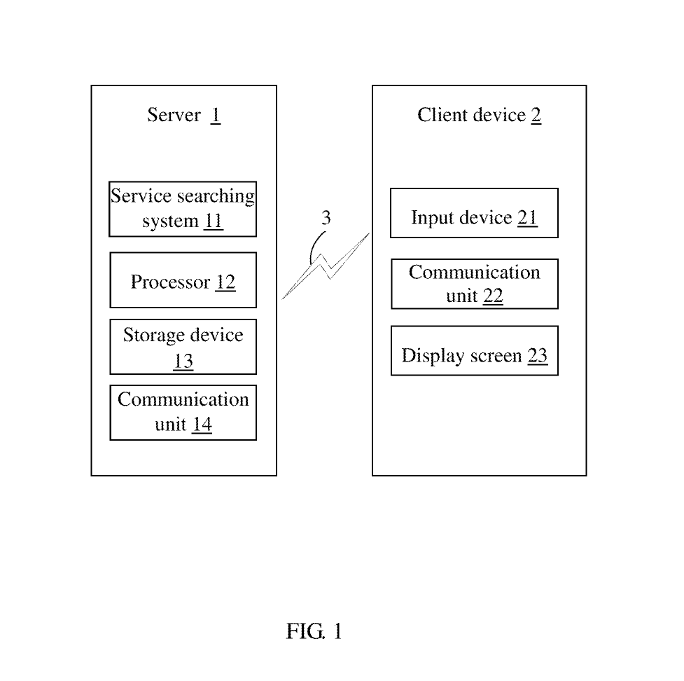

FIG. 1 illustrates a block diagram of an example embodiment of a server. In at least one embodiment as shown in FIG. 1, a server 1 can include, but is not limited to, a service searching system 11, at least one processor 12, a storage device 13, and a first communication unit 14. FIG. 1 illustrates only one example of the server 1, other examples can comprise more or fewer components than those shown in the embodiment, or have a different configuration of the various components.

The at least one processor 12 executes one or more computerized codes and other applications of the server 1 to provide functions of the server 1. The storage device 13 can be an internal storage device, such as a random access memory (RAM) for temporary storage of information, and/or a read only memory (ROM) for permanent storage of information. The storage device 13 can also be an external storage device, such as an external hard disk, a storage card, or a data storage medium.

In at least one embodiment, the storage device 13 stores a plurality of service categories and uniform resource locators (URLs) of one or more websites corresponding to each of the service categories. Each of the service categories are divided according to a type of service provided by each of the websites. In other embodiments, the service categories can be divided according to user requirements.

In at least one embodiment, the server 1 is connected to a client device 2 through a network 3 (for example, the Internet or an intranet). The server 1 can transmit data to the client device 2 and receive data from the client device 2 via the first communication unit 14 and a second communication unit 22 of the client device 2. The client device 2 further includes an input device 21 and a display screen 23. The client device 2 can input characters, images, gestures, voices using the input device 21. The input device 21 can be a physical/virtual keyboard, a touch device, or a voice recognition module, for example. The display screen 23 can display data of the client device 2, such as, data received from the server 1, for example.

The service searching system 11 may use a search engine application programming interface (API) (not shown) of the server to permit users to search for information on the world wide web and to obtain search results. In at least one embodiment, the service searching system 11 can provide a searching interface which includes different service categories, and searches for information in one or more websites corresponding to a selected service category from the searching interface to obtain search results. The service searching system 11 further simplifies the search results and outputs the simplified search results to the client device 2.

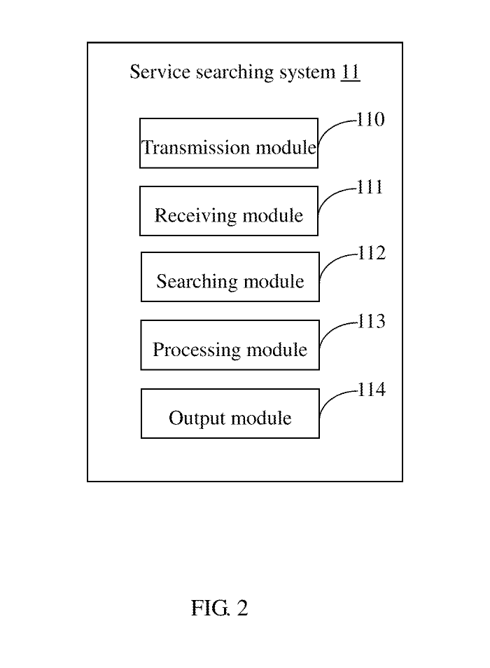

FIG. 2 illustrates a block diagram of an example embodiment of a service searching system in the server of FIG. 1. In at least one embodiment, the service searching system 11 can include, but is not limited to, a transmission module 110, a receiving module 111, a searching module 112, a processing module 113, and an output module 114. The modules 110-114 can include computerized instructions in the form of one or more computer-readable programs that can be stored in a non-transitory computer-readable medium, such as the storage device 13, and be executed by the at least one processor 12 of the server 1.

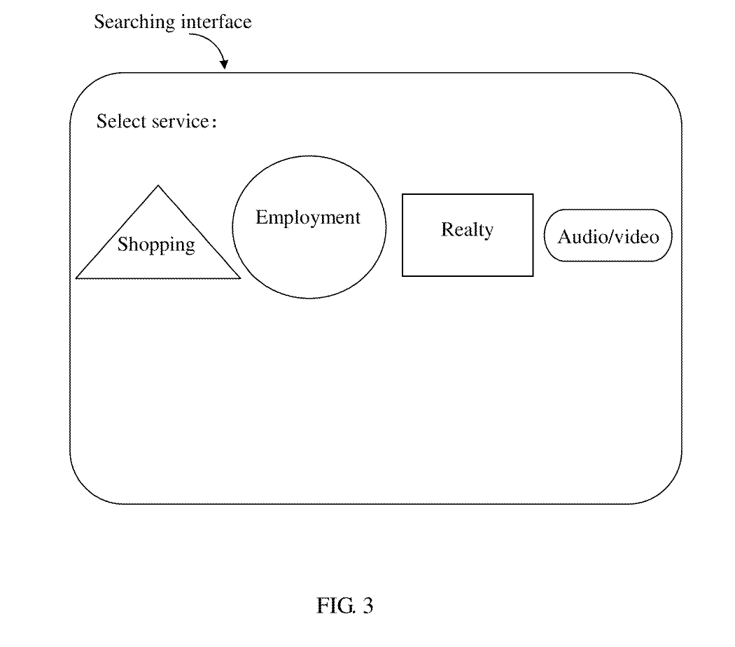

When the server 1 receives a preset access request from the client device 2, the transmission module 110 transmits a searching interface to the client device 2 to be displayed on the display screen 23 of the client device 2. The searching interface can be shown as in FIG. 3. There is a plurality of icons of different service categories on the searching interface, as shown in FIG. 3, the service categories can include, but is not limited to, shopping, employment, realty, audio/video and other service categories. Shapes and colors of the plurality of icons corresponding to the plurality of service categories are different.

After the client device 2 receives the searching interface from the server 1, a user of the client device 2 can select one service category to be searched by clicking one of the icons on the searching interface. After the user selects the service category, the icon of the selected service category, a search box and a preset return button are displayed on the searching interface, and icons of unselected service categories are not displayed on the searching interface. The client device 2 can input a keyword (one or more characters or images) in the search box. If the user wants to reselect another service category, the user can click the preset return button to return to display the searching user interface which includes the plurality of icons of the different service categories.

The receiving module 111 receives the selected service category from the searching interface and a keyword input from the searching interface by the client device 2.

The searching module 112 confirms one or more websites corresponding to the selected service category, and obtains search results by searching for the input keyword from the confirmed websites. In at least one embodiment, the searching module 112 determines URLs of the one or more websites corresponding to the selected service category from the storage device 13, and searches for the input keyword from each webpage of the determined URLs. If one web page of the determined URLs includes the input keyword, the web page of the determined URLs is determined to be a search result.

The processing module 113 simplifies the search results by filtering repeated search results. In at least one embodiment, if at least two search results have the same content, the processing module 113 can determine that the at least two search results are the repeated search results. The processing module 113 further reserves one of the repeated search results, and deletes other search results of the repeated search results.

The output module 114 sorts the simplified search results in a preset manner, and outputs the simplified search results in a preset format to be displayed on the display screen 23 of the client device 2. The preset manner can be a preset order which is set according to each of websites in the simplified search results.

It should be understood, if the plurality of websites have been registered in the server 1 and have made an agreement on a preset sharing protocol. One registered website can publish a piece of service information. The service searching system 11 can publish the piece of service information in a preset format (for example, a link format) on other registered websites.

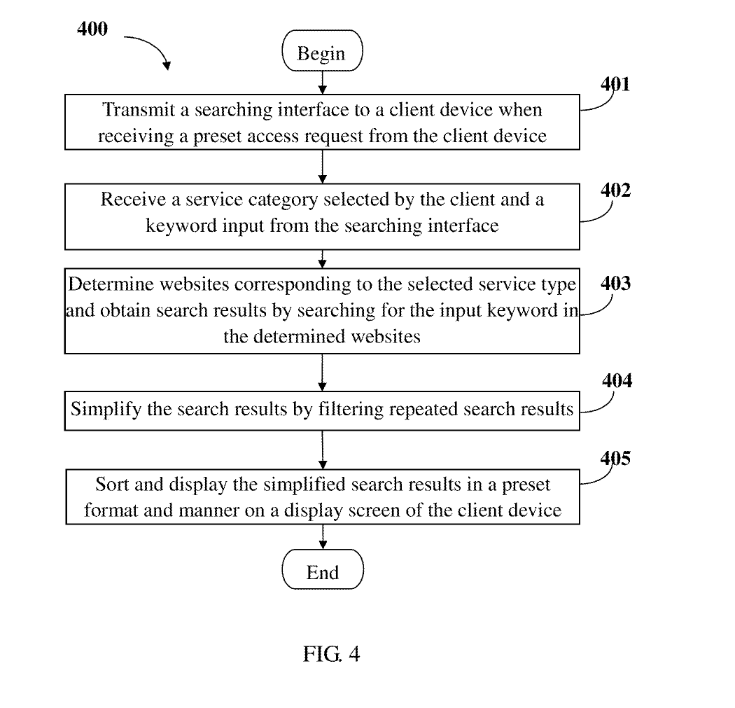

Referring to FIG. 4, a flowchart is presented in accordance with an example embodiment. An example method 400 is provided by way of example, as there are a variety of ways to carry out the method. The example method 400 described below can be carried out using the configurations illustrated in FIGS. 1-3, for example, and various elements of these figures are referenced in explaining the example method 400. Each block shown in FIG. 4 represents one or more processes, methods, or subroutines, carried out in the example method 400. Furthermore, the illustrated order of blocks is illustrative only and the order of the blocks can be changed. Additional blocks can be added or fewer blocks can be utilized without departing from this disclosure. The example method 400 can begin at block 401.

At block 401, when the server 1 receives a preset access request from the client device 2, a transmission module transmits a searching interface to the client device 2 for displaying the searching interface on the display screen 23. There is a plurality of icons of different service categories on the searching interface. Shapes and colors of the icons corresponding to the different service categories can be different.

After the client device 2 receives the searching interface from the server 1, a user of the client device 2 can select one service category to be searched by clicking one of the icons from the searching interface. After the user selects the service category, the icon of the selected service category, a search box and a preset return button are displayed on the searching interface, and icons of unselected service categories are not display on the searching interface. The client device 2 can input a keyword in the search box. If the user wants to reselect another service category, the user can click the preset return button to return to the searching interface which includes the plurality of icons of the different service categories.

At block 402, a receiving module receives the selected service category and a keyword input from the searching interface by the client device 2.

At block 403, a searching module confirms one or more websites corresponding to the selected service category, and obtains search results by searching for the input keyword from the confirmed websites. In at least one embodiment, the searching module 112 determines URLs of the one or more websites corresponding to the selected service category from the storage device 13, and searches for the input keyword from each webpage of the determined URLs. If one web page of the determined URLs includes the input keyword, the web page of the determined URLs is determined to be a search result.

At block 404, a processing module simplifies the search results by filtering repeated search results. In at least one embodiment, if at least two search results have the same content, the processing module can determine that the at least two search results are the repeated search results. The processing module further reserves one of the repeated search results, and deletes other search results of the repeated search results.

At block 405, an output module sorts the simplified search results in a preset manner (for example, in a preset order), and displays the simplified search results in a preset format on the display screen 23 of the client device 2. The preset order can be set according to attention of each of websites in the simplified search results.

All of the processes described above can be embodied in, and fully automated via, functional code modules executed by one or more general purpose processors such as the processor 12. The code modules can be stored in any type of non-transitory readable medium or other storage device such as the storage device 13. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-based service searching method of a server, the method being executed by at least one processor of the server, the method comprising:
transmitting a searching interface to a client device when the server receives a preset access request from the client device, the searching interface comprising a plurality of icons, each icon corresponding to a service category;
receiving a selection of a service category via searching interface and a keyword input from the searching interface by the client device;
confirming one or more websites corresponding to the selected service category, and obtaining search results by searching for the input keyword from the confirmed websites;
sorting the search results in a preset manner, and displaying the search results in a preset format on a display screen of the client device.

2. The method of claim 1, further comprising:
simplifying the search results by filtering repeated search results, and wherein the search results are filtered by:
determining that at least two search result are the repeated search results when the at least two search results have same content; and
reserving one of the repeated search results, and deleting search results of the repeated search results.

3. The method of claim 1, wherein the one or more websites corresponding to the selected service category are confirmed by:
determining uniform resource locators (URLs) of the one or more websites corresponding to the selected service category from a storage device of the server, the storage device storing the plurality of service categories and the URLs of the one or more websites corresponding to each of the plurality of service categories, and each of the plurality of service categories being divided according to a type of service provided by each of the websites.

4. The method of claim 3, wherein search results are searched by:
searching for the input keyword from each webpage of the determined URLs;
determining each webpage of the determined URLs to be a search result when the each webpage of the determined URLs comprises the input keyword.

5. The method of claim 1, further comprising:
displaying the icon of the selected service category, a search box and a preset return button on the searching interface, when one of the plurality of service categories is selected by the client device;
receiving a keyword input from the search box by the client device; and
displaying the searching interface comprising the plurality of icons of the plurality of service categories when the preset return button is clicked.

6. The method of claim 1, wherein the plurality of icons corresponding to the plurality of service categories have different shapes and colors.

7. A non-transitory computer-readable medium having stored thereon instructions that, when executed by at least one processor of a server, causing the server to perform a service searching method, the method comprising:
transmitting a searching interface to a client device when the server receives a preset access request from the client device, the searching interface comprising a plurality of icons, each icon corresponding to a service category;
receiving a selection of a service category selected from the searching interface and a keyword input from the searching interface by the client device;
confirming one or more websites corresponding to the selected service category, and obtaining search results by searching for the input keyword from the confirmed websites;
sorting the search results in a preset manner, and displaying the search results in a preset format on a display screen of the client device.

8. The non-transitory computer-readable medium of claim 7, wherein the method further comprises:
simplifying the search results by filtering repeated search results, and wherein the search results are filtered by:
determining that at least two search result are the repeated search results when the at least two search results have the same content; and
reserving one of the repeated search results, and deleting search results of the repeated search results.

9. The non-transitory computer-readable medium of claim 7, wherein the one or more websites corresponding to the selected service category are confirmed by:
determining uniform resource locators (URLs) of the one or more websites corresponding to the selected service category from a storage device of the server, the storage device storing the plurality of service categories and URLs of the one or more websites corresponding to each of the plurality of service categories, and each of the plurality of service categories being divided according to a type of service provided by each of the websites.

10. The non-transitory computer-readable medium of claim 9, wherein search results are searched by:
searching for the input keyword from each webpage of the determined URLs; and
determining each webpage of the determined URLs to be a search result when the each webpage of the determined URLs comprises the input keyword.

11. The non-transitory computer-readable medium of claim 7, wherein the method further comprises:
displaying the icon of the selected service category, a search box and a preset return button on the searching user interface, when one of the plurality of service categories is selected by the client device;
receiving a keyword input from the search box by the client device; and
displaying the searching user interface comprising the plurality of icons of the plurality of service categories, when the preset return button is clicked.

12. The non-transitory computer-readable medium of claim 7, wherein the plurality of icons corresponding to the plurality of service categories have different shapes and colors.

13. A server comprising:
at least one processor; and
a storage device that stores one or more programs which, when executed by the at least one processor, cause the at least one processor to:
transmit a searching interface to a client device when the server receives a preset access request from the client device, the searching interface comprising a plurality of icons, each icon corresponding to a service category;
receiving a selection of a service category selected from the searching interface and a keyword input from the searching interface by the client device;
confirm one or more websites corresponding to the selected service category, and obtaining search results by searching for the input keyword from the confirmed websites;
sort the search results in a preset manner and display the search results in a preset format on a display screen of the client device.

14. The server of claim 13, wherein the at least one processor further simplifies the search results by filtering repeated search results, and wherein the search results are filtered by:
determining that at least two search result are the repeated search results when the at least two search results have same content; and
reserving one of the repeated search results, and deleting search results of the repeated search results.

15. The server of claim 13, wherein the storage device stores the plurality of service categories and uniform resource locators (URLs) of the one or more websites corresponding to each of the plurality of service categories, and each of the plurality of service categories being divided according to a type of service provided by each of the websites.

16. The server of claim 15, wherein the search results are searched by:
searching for the input keyword from each webpage of the determined URLs; and
determining each webpage of the determined URLs to be a search result when the each webpage of the determined URLs comprises the input keyword.

17. The server of claim 13, wherein the at least one processor further:
displays the icon of the selected service category, a search box and a preset return button on the searching user interface, after one of the plurality of service categories is selected by the client device;
receives a keyword input from the search box by the client device; and
displays the searching user interface comprising the plurality of icons of the plurality of service categories, when the preset return button is clicked.

18. The server of claim 13, wherein the plurality of icons corresponding to the plurality of service categories have different shapes and colors.
